(19) United States
(12) Patent Application Publication
(10) Pub. No.: US 2024/0074470 A1
(43) Pub. Date: Mar. 7, 2024

(54) Device for Refining the Taste of Beverages

(71) Applicant: Johann Kreutzinger, Rehetobel (CH)

(72) Inventor: Johann Kreutzinger, Rehetobel (CH)

(21) Appl. No.: 17/939,600

(22) Filed: Sep. 7, 2022

(51) Int. Cl. A23L 5/30; A23L 2/00; C12H 1/16

(52) U.S. Cl. CPC A23L 5/36; A23L 2/00; C12H 1/165

(57) ABSTRACT

The present invention relates to a device 1 for refining the taste of beverages 7 with an irradiation chamber 2, wherein the irradiation chamber 2 is configured to receive a beverage vessel 6, in particular a beverage glass or a beverage bottle, and at least one radiation source 9, the at least one radiation source 9 being arranged within the irradiation chamber 2 and is configured to emit a first radiation 10 with a wavelength out of a wavelength range between 270 nm and 450 nm, wherein the beverage vessel 6 is providable in the irradiation chamber 2 to be irradiated with the first radiation 10.

### FIELD OF THE INVENTION

The present invention relates to a device for refining the taste of beverages with an irradiation chamber, wherein the irradiation chamber is configured to receive a beverage vessel, in particular a beverage glass or a beverage bottle, and at least one radiation source, the at least one radiation source being arranged within the irradiation chamber and is configured to emit a first radiation with a wavelength out of a wavelength range between 270 nm and 450 nm, wherein the beverage vessel is providable in the irradiation chamber to be irradiated with the first radiation.

### BACKGROUND OF THE INVENTION

A large number of beverages, however, in addition to having the desired delicious taste and aroma, have an extremely strong bitter note or cause a strong burning sensation in the mouth and throat area after drinking the beverage.

Thus, in addition to its revitalizing properties, freshly brewed coffee has a fragrant aroma and the well-known delicious taste, which is why coffee has many fans worldwide. Furthermore, there are many people who like the described aroma and taste of coffee, but who are deterred from regular consumption by the extremely bitter aftertaste of coffee. Although people often try to overcome this bitter taste by adding milk and/or sugar, this is only a temporary solution for many people and is probably becoming increasingly unattractive in view of increasing lactose intolerance and diabetes.

Alcoholic beverages such as spirits, including brandy in particular, are also enjoyed by many people around the world because of their great aroma and taste. However, high-proof spirits in particular often cause an unpleasant burning and scratching sensation in the throat after drinking, which prevents many consumers from drinking these spirits regularly.

Consequently, there is a permanent need for new methods, devices and systems to refine the taste of beverages such as coffee or spirits, in particular to remove extremely bitter aftertastes and unpleasant burning sensations in the mouth without altering the desired aroma and taste.

### OBJECT OF THE INVENTION

It is therefore an object of the invention to provide a device for refining the taste of beverages.

It is therefore a further object of the invention to provide a method for refining the taste of beverages.

These objects are achieved by realizing at least part of the features of the independent claims. Features which further develop the invention in an alternative or advantageous manner are described in the dependent patent claims.

### SUMMARY OF THE INVENTION

The present invention relates to a device for refining the taste of beverages with an irradiation chamber, wherein the irradiation chamber is configured to receive a beverage vessel, in particular a beverage glass or a beverage bottle, and at least one radiation source, the at least one radiation source being arranged within the irradiation chamber, and is configured to emit a first radiation with a wavelength out of a wavelength range between 270 nm and 450 nm, wherein the beverage vessel is providable in the irradiation chamber to be irradiated with the first radiation.

This invention has the advantage that beverages which, in addition to the desired aroma, have, for example, an unpleasant aftertaste or a very strong bitter note, can be refined in taste and thus a greater drinking pleasure is created for the consumer. By using the device according to the invention, in particular by irradiating the beverage with the first radiation, among other things the unpleasant aftertaste, an unpleasant (mouth/throat) scratching caused by the beverage, an unpleasant pungency and/or the unpleasant bitter note can be removed, leaving only the desired delicious taste and the desired delicious aroma of the beverage, resulting in a taste refinement of the beverage.

For example, by treating coffee by means of the device according to the invention, the strong bitter note of coffee can be softened or even completely removed (dependent on the irradiation time), allowing people who like the taste and aroma of coffee in principle, but for whom the beverage was previously too bitter, to now consume a tastefully refined, mild coffee in accordance with their wishes.

Another exemplary application of the device according to the invention is the treatment of high-percentage, sharp spirituous (alcoholic) beverages that cause an unpleasant scratchy throat/mouth sensation to the consumer. By irradiating the spirit/liquor with the first radiation, the sharpness and/or throat scratching in the aftertaste is removed without changing the taste and aroma of the spirituous beverage. In this way, even very high-proof/sharp spirits can be consumed by people who were previously put off by the unpleasant throat scratching/mouthfeel. Furthermore, inexpensive spirits that were previously avoided because of their strong burning sensation in the mouth and the strong throat scratching can be refined in taste and thus made attractive to more people.

In a further embodiment, the irradiation chamber comprises at least one side wall, the at least one side wall completely surrounding the irradiation chamber, a cover, wherein the cover is connected to the at least one side wall, and an opening, wherein the opening is arranged opposite the cover.

This embodiment has the advantage that the irradiation chamber is sealed against an exit of radiation or light, in particular of the first radiation, at the areas surrounded by the side wall and the cover. The first radiation can therefore only exit the irradiation chamber in the region outside the irradiation chamber where the opening is located. If, for example, the side wall is the lateral surface of a cylinder and the cover is the top surface of the cylinder, the base surface lying opposite the top surface of the cylinder represents the opening.

In a further embodiment, the opening of the irradiation chamber is placed over the beverage vessel on a straight opaque surface, in particular a table top.

This embodiment has the advantage that as soon as the opening is placed on a solid, straight, light-impermeable surface, such as a table top, the opening is covered and the irradiation chamber becomes a completely sealed, non-transmissive irradiation chamber. In this way, the opening and thus the irradiation chamber can be placed over, for example, a shot glass, a coffee cup or a liquor bottle (depending on the size of the irradiation chamber), the shot glass, the coffee cup or the liquor bottle can be irradiated and thus their contents refined in terms of taste without radiation, in particular UV radiation that is harmful to the skin and eyes, escaping from the irradiation chamber. Due to this considerable safety advantage, beverages on a restaurant table or a bar counter can thus also be irradiated and thus refined immediately before consumption without the surrounding persons being harmed by the radiation and/or having to leave the room or keep a large safety distance. In this way, the device according to the invention provides a simple, fast but also safe way to refine beverages, which is why, in addition to an industrial application for the production of large quantities of refined beverages (entire tanks can also be placed in the irradiation chamber and irradiated, provided that the tanks are permeable to the first radiation), the device can also be used in bars, cafes, restaurants, etc. or in private homes.

In a further embodiment, the irradiation chamber further comprises a base, wherein the base is arranged opposite the cover and connected to the at least one side wall such that the opening is covered.

This embodiment has the advantage that even if the device is not placed on a solid, straight, light-impermeable surface, such as a table top, the irradiation chamber is a completely sealed, non-transmissive irradiation chamber. This provides an additional safety advantage, since even if the irradiation chamber is accidentally lifted or dropped/flipped, the first radiation cannot exit into an area outside the irradiation chamber. Especially for the use of the device in a bar, where many people are crowded together and the people are sometimes alcoholized and careless, or in a private household where children are also present, an all-around closed irradiation chamber is very useful for safety reasons.

In a further embodiment, the irradiation chamber is non-transmissive to the first radiation in a region outside the irradiation chamber (e.g. the irradiation chamber is sealed with walls, covers, doors, an opaque surface, a table top, etc.).

Since the first radiation is in the wavelength range between 270 nm and 450 nm and thus partly in the UV range, it is particularly important for safety reasons that the first radiation cannot leak into a region outside the irradiation chamber. It is known that UV radiation, especially intense UV radiation from a short distance, can damage the eyes (retina), the skin (sunburn) and even DNA.

In a further embodiment, the irradiation chamber further comprises at least one sealable opening (e.g. a door), wherein the at least one sealable opening is openable and closable, wherein the beverage vessel is placeable through the at least one opened sealable opening into the irradiation chamber and the irradiation chamber is closed by the at least one sealable opening non-transmissive to the first radiation.

This embodiment has the advantage that the irradiation chamber is in principle non-transmissive to the first radiation, but before irradiation a sealable opening (e.g. door/flap/hatch/port) of the irradiation chamber can simply be opened, the beverage vessel, in particular a beverage glass or a beverage bottle, can simply be inserted into the irradiation chamber, the sealable opening (e.g. door/flap/hatch/port) of the irradiation chamber can be closed again and then the beverage can be irradiated simply and safely. After irradiation of the beverage, the beverage vessel, in particular a beverage glass or a beverage bottle, can be removed again through the open sealable opening (e.g. door/flap/hatch/port) of the irradiation chamber without having to lift the entire device, for example.

In a further embodiment, the at least one sealable opening is comprised by the at least one side wall, and/or the cover and/or the base is removable and in this way acts as the at least one sealable opening.

In a further embodiment, the at least one radiation source is configured to emit the first radiation with a wavelength out of a first wavelength range between 270 nm and 400 nm, and is configured to emit a second radiation with a wavelength out of a second wavelength range between 400 nm and 450 nm, wherein the beverage vessel is providable in the irradiation chamber to be irradiated with both the first radiation and the second radiation.

This embodiment has the advantage that certain beverages obtain even better taste during refinement when the beverage is irradiated with both the first and second radiations.

In a further embodiment, the at least one radiation source is attached to the side wall and/or to the cover and/or to the base, and directly irradiates the beverage vessel.

This embodiment has the advantage that the radiation source can be flexibly positioned in the irradiation chamber to achieve a desired distance to the beverage, intensity of irradiation, penetration of the beverage and/or the vessel wall, etc.

The direct irradiation ensures that the beverage is sufficiently penetrated with radiation, even if a wall of the beverage vessel lies between the radiation source and the beverage. Furthermore, the radiation source can also be attached to the cover of the irradiation chamber in order to be able to directly irradiate the contents of a glass, for example, from above and thus achieve a high intensity of irradiation of the beverage.

In a further embodiment, the at least one radiation source is configured as an ultraviolet light-emitting diode.

Ultraviolet light-emitting diodes represent an inexpensive and safe radiation source, which emits radiation with a wavelength out of the desired wavelength range (first radiation with a wavelength out of a wavelength range between 270 nm and 450 nm). This has the advantage that the device according to the invention can be produced very economically. Furthermore, the intensity of the irradiation, the direction of the irradiation, etc. can be controlled via the number of UV LEDs used. The UV LEDs (e.g. individual UV LEDs or UV LED rows) can also be easily attached to the side wall and/or to the cover and/or to the base of the irradiation chamber by means of a mounting device (e.g. screw or glue, etc.).

In a further embodiment, the at least one side wall and/or the cover of the irradiation chamber comprises at least one mirror, in particular wherein the beverage vessel is indirectly irradiatable by means of the at least one mirror.

This embodiment has the advantage that radiation which does not hit the beverage directly from the radiation source is mirrored and thus finds its way onto the beverage. In this way the radiation of the radiation source can be used in an optimal way and even with a smaller number of radiation sources (e.g. UV LEDs) a high intensity of the irradiation of the beverage can be achieved.

In a further embodiment, the at least one mirror comprises aluminum and/or gold and/or iron, in particular wherein the at least one mirror is an aluminum sheet or a (stainless) steel sheet.

Aluminum and gold are metals that reflect radiation in a wavelength range of the first radiation. Since aluminum is inexpensive and easy to process, it makes sense to use this material for the mirror in the device. This embodiment has the advantage that the aluminum mirror (e.g. a sheet of aluminum) can be easily adapted to the shape of the irradiation chamber or even that the whole and/or parts of the irradiation chamber are made of aluminum. Due to the low price of aluminum, this enables a low-cost production of the device according to the invention.

In a further embodiment, the irradiation chamber has a volume in the range of 100 cm³ to 50000 cm³, in particular in the range of 800 cm³ to 8000 cm³, and/or a diameter in the range of 5 cm to 40 cm, in particular in the range of 10 cm to 20 cm, and/or a height in the range of 10 cm to 40 cm, in particular in the range of 10 cm to 25 cm.

This embodiment has the advantage that the irradiation chamber can be adapted to the size of the beverage vessel. Especially for the bar or restaurant business, where customers may irradiate their beverages at the table, it is sufficient if the irradiation chamber is large enough to hold a brandy glass or a coffee cup. For the seller of beverages (e.g. spirits), it may be relevant that the irradiation chamber holds an entire (liquor) bottle, and the manufacturer of beverages (e.g. spirits) may want to irradiate entire tanks with the beverage, which requires a significantly larger irradiation chamber.

In a further embodiment, the irradiation chamber comprises the shape of a polygon, or a cuboid, in particular as a cube, or a prism, or a cylinder.

This embodiment has the advantage that the shape of the irradiation chamber and thus, for example, the shape of the entire device can be adapted according to the wishes of the customers. In this way, different designs of the device can be realized in order to address several customer groups. Furthermore, the variation of the shape of the irradiation chamber/device allows to react flexibly to the input of the manufacturer of the irradiation chamber/device as a whole regarding feasibility, workability, manufacturing price, stock, etc.

In a further embodiment, the device further comprises a power source for operating the radiation source.

In a further embodiment, the power source is at least one battery and/or at least one rechargeable battery and/or a connection cable for an external power supply.

This embodiment has the advantage that the power supply of the device can be provided according to the wishes of the customer. For example, for bars it is important for practical reasons that the device according to the invention is battery-powered, so that the customer can, for example, refine the drink on his table without having unsightly/impractical cables lying around on the table or the floor over which people can trip. For a use of the device according to the invention for beverage production, on the other hand, a permanent and energy-intensive (e.g. especially for the irradiation of whole tanks) irradiation of the beverage is necessary, which can only/mainly be achieved by an external power supply via a cable.

In a further embodiment, the device further comprises a switch, wherein by means of the switch a power supply provided by the power source to the at least one radiation source is switched on and off.

This embodiment has the advantage that the power supply of the device can be provided if it is desired to irradiate the beverage. In this way, it is prevented that the radiation is permanently on and thus, for example, an irradiation of the user occurs when the irradiation chamber is put over a beverage vessel. According to the invention, the user can put the irradiation chamber over the beverage vessel when it is switched off and then (as soon as it is safe to use the device) start the irradiation by means of the switch.

In a further embodiment, the device further comprises a detector (e.g. inclination/tilt sensors, optical sensors, contact sensors, etc.), wherein the detector is configured to detect working states of the device.

In a further embodiment, the detector (e.g. an optical sensor of the type CCD or CMOS sensor) is configured to detect as a working state when radiation, in particular the first radiation, exits the irradiation chamber.

In order to be able to optimally monitor the state of the irradiation of the beverage and thus also the state of the refinement, it is important that the device has a detector which detects working states. Especially with regard to safety aspects, in particular whether radiation, in particular the first radiation, exits the irradiation chamber, it is particularly advantageous to detect precisely this state of an exiting radiation quickly and reliably.

In a further embodiment, the device further comprises an automated safety shutdown as a function of detected working states, in particular wherein the automated safety shutdown is configured to switch off the power supply provided by the power source to the at least one radiation source as soon as radiation, in particular the first radiation, exits the irradiation chamber.

This embodiment has the advantage that if radiation, in particular the first radiation, exits the irradiation chamber and thus a hazard to the user of the device occurs, this state is detected and an emergency shutdown of the irradiation is automatically performed to protect the user from harmful irradiation.

In a further embodiment, the device further comprises a timer, wherein after expiration of a time set by means of the timer, the power supply provided by the power source to the at least one radiation source is automatically switched off.

In a further embodiment, the user of the device is notified of the expiration of the timer by means of an acoustic signal (e.g., a loud ringing) and/or a visual signal (e.g., an illuminated lamp).

This embodiment has the advantage that the desired irradiation time, for example also depending on the type or volume of the beverage, can be set in advance in order to achieve optimum refinement of the beverage, and so the user no longer has be concerned about the duration of the irradiation, but the irradiation switches off automatically after the set timer has expired. In this way, a simplified use of the device is achieved and thus a greater customer comfort.

In a further embodiment, the device further comprises a display, wherein, by means of the display a type of beverage to be irradiated, a volume of the beverage to be irradiated, a type of beverage vessel, in particular beverage glasses or beverage bottles, and/or the time set by means of the timer and thus a duration of the irradiation is adjustable.

This embodiment has the advantage that the user of the device can very clearly and easily make certain settings and selections and thus achieve an optimized refinement of the beverage. In addition, the user has the timer set visibly in front of him and can thus see directly when the beverage has been irradiated.

The present invention further relates to a method for refining the taste of beverages, the method comprising the following steps:
inserting a beverage into a vessel, wherein the vessel is configured for containing the beverage,
locating the vessel within an irradiation zone, in particular an irradiation chamber, and
irradiating the irradiation zone for an irradiation time with a first radiation in the wavelength range from 270 nm to 400 nm and a second radiation in the wavelength range from 400 nm to 450 nm.

This invention has the advantage that by means of the method according to the invention, beverages can be refined in taste, for example, an unpleasant aftertaste or a very strong bitter note of the beverage can be removed and thus a greater drinking pleasure for the consumer can be provided. By irradiating the beverage with both the first radiation and the second radiation, certain beverages obtain even better taste during refinement compared to the use of only one of the two radiations or even the use of a radiation over a significantly larger wavelength range, which includes the first and second radiation. The method can be used for a discontinuous process, i.e. the beverage is filled for example into a tank or into a glass, then the vessel with the beverage is irradiated in the irradiation zone and after irradiation the refined beverage is removed from the vessel. Furthermore, the method can also be used for a continuous process, where for example the beverage is transported through a flow tube (e.g. the beverage is pumped through the flow tube by a pump or the flow tube acts as a kind of down pipe), where the flow tube runs through the irradiation zone and the beverage flowing through the flow tube is irradiated with the first and second radiation (the wall of the flow tube must be at least partly transmissive for the first and second radiation).

In a further embodiment, the method further comprises the step of sealing the irradiation zone against exit of radiation, in particular the first radiation and the second radiation, in a region outside the irradiation zone.

This embodiment has the advantage that no radiation can escape from the irradiation zone and thus persons are protected from damage by the radiation. In particular, radiation of the described wavelength range is mostly in the UV wavelength range, which is why exposure from a short distance and high intensity/duration can lead to skin or DNA damage.

In a further embodiment, the irradiation of the irradiation zone is performed directly by the first radiation and the second radiation and/or indirectly by a reflection of the first radiation and the second radiation, the irradiation time is in the range of 5 s to 900 s, in particular in the range of 30 s to 120 s, a vessel wall forming the vessel is configured to form an opening so that the first radiation and the second radiation impinge on the beverage in the vessel, and/or be transmissive for the first radiation and the second radiation.

This embodiment has the advantage that (by direct and/or indirect irradiation of the beverage) the beverage is sufficiently penetrated with radiation, even if a wall of the beverage vessel lies between the radiation source and the beverage. When using a glass as a beverage vessel, on the other hand, the radiation can reach the beverage directly through the opening of the glass (the radiation does not have to pass through the wall of the glass), which is why it is advantageous to provide the irradiation (e.g. attaching a radiation source to the top of the irradiation zone) in such a way that the radiation passes through the opening of the glass.

In a further embodiment, the beverage is an alcoholic beverage, in particular a beverage of the type spirituose.

The effect of taste refinement was found by treating spirits/liquors with the method according to the invention, in particular irradiation with both the first and the second radiation, the sharpness and/or throat scratching in the aftertaste is removed without changing the taste and aroma of the spirituous beverage. In this way, even very high-proof/sharp spirits can be consumed by people who were previously put off by the unpleasant throat scratching/mouthfeel.

In a further embodiment, the beverage is a non-alcoholic beverage, in particular a beverage of the type coffee.

The effect of taste refinement was found by treating non-alcoholic beverages as, for example, coffee by means of the method according to the invention. In this way, the bitter note of coffee can be softened or even completely removed (dependent on the irradiation time), allowing people who like the taste and aroma of coffee in principle, but for whom the beverage was previously too bitter, to now consume a tastefully refined, mild coffee in accordance with their wishes.

In a further embodiment, the vessel is configured as beverage glass or beverage bottle.

As described above, the method according to the invention can be used for a discontinuous process, i.e. the beverage is filled for example into a tank or into a glass, oder for a continuous process, where for example the beverage is transported through a flow tube.

In a further embodiment, the reflection of the first radiation and the second radiation to indirectly irradiate the irradiation zone is generated by at least one mirror, in particular wherein the at least one mirror comprises aluminum and/or gold and/or iron.

The present invention further relates to a device for refining the taste of beverages with an irradiation chamber, a beverage line, in particular a flow tube, wherein the beverage line is configured to be continuously flowed through with the beverage, and at least one radiation source, the at least one radiation source is configured to emit a first radiation with a wavelength out of a wavelength range between 270 nm and 450 nm, wherein the beverage line and the at least one radiation source being arranged in the irradiation chamber to provide irradiation of the beverage line with the first radiation.

This invention also has the advantage that beverages which, in addition to the desired aroma, have, for example, an unpleasant aftertaste or a very strong bitter note, can be refined in taste and thus a greater drinking pleasure is created for the consumer. In this case, the beverage line is continuously flowed through (e.g. beverage is pumped through a flow tube), which entails a completely different application field than in a device for a discontinuous refinement of beverages (e.g. irradiation of a beverage glass). Thus, the use of the device according to the invention is particularly interesting for industrial beverage production, since it is necessary/usual for this to flow/pump larger volumes of beverages through pipes in order to generate the largest and fastest possible throughput. In this case, discontinuous processes would be too time-consuming and cost-intensive.

Another possible application for the device according to the invention would be the use in a coffee machine. Here, the brewed coffee is pumped through pipes/hoses towards an outlet, which is why there is a continuous process. Irradiation and thus flavor refinement of coffee (coffee is too bitter for many people and by treating coffee by means of the device according to the invention, this bitter note is mitigated or even completely removed) can be performed with the device according to the invention while the coffee is pumped through the pipes/hoses towards an outlet (pipes/hoses are directed through the irradiation zone and irradiated with the first radiation in this zone, pipes/hoses must be (partially) transmissive for the first radiation at least in the irradiation zone), without the consumer having to wait longer for his refined coffee. A discontinuous process (e.g. irradiation of the coffee in the cup or irradiation of the coffee in a reservoir inside the coffee machine) would lead to another time consuming processing step, which would be disadvantageous for the consumer.

In a further embodiment, a flow rate of the beverage through the beverage line is adjustable such that the duration of the flow of the beverage through the irradiation chamber and thus the duration of the irradiation of the beverage with the first radiation corresponds to a duration to refine the taste of the beverage, in particular wherein the irradiation duration to refine the taste of the beverage is in the range of 5 s to 900 s, in particular in the range of 30 s to 120 s.

This embodiment has the advantage that by means of the variable flow rate, the irradiation time of the beverage can also be adjusted, which is why, for example, depending on the volume or type of beverage, the taste of the beverage can also be refined according to the user's wishes in a continuous process. The effect of taste refinement is dependent on the dose of irradiation, with the irradiation dose being proportional to the irradiation time. Furthermore, in a (continuous) flow system, the irradiation dose is inversely proportional to the flow rate of the beverage.

In a further embodiment, the at least one radiation source is configured to emit the first radiation with a wavelength out of a first wavelength range between 270 nm and 400 nm, and is configured to emit a second radiation with a wavelength out of a second wavelength range between 400 nm and 450 nm, wherein the beverage line and the at least one radiation source being arranged in the irradiation chamber to provide irradiation of the beverage line with both the first radiation and the second radiation.

This embodiment has the advantage that, for certain beverages (e.g. certain spirits) taste refinement occurs even better when the beverage is irradiated with both the first and second radiations.

In a further embodiment, the at least one radiation source is configured as an ultraviolet light-emitting diode.

As described above, ultraviolet light-emitting diodes are an inexpensive and safe radiation source which emits radiation with a wavelength out of the desired wavelength range. This has the advantage that the device according to the invention can be produced very economically. Furthermore, the intensity of the irradiation, the direction of the irradiation, etc. can be controlled via the number of UV LEDs used.

In a further embodiment, the irradiation chamber comprises at least one mirror, in particular wherein the beverage line is indirectly irradiatable by means of the at least one mirror.

In a further embodiment, the at least one mirror comprises aluminum and/or gold and/or iron, in particular wherein the at least one mirror is an aluminum sheet or a (stainless) steel sheet.

These embodiments have the advantage that radiation which does not hit the beverage directly from the radiation source is mirrored and thus finds its way onto the beverage. In this way the radiation of the radiation source can be used in an optimal way and even with a smaller number of radiation sources (e.g. UV LEDs) a high intensity of the irradiation of the beverage can be achieved. Further, the aluminum mirror (e.g. a sheet of aluminum) can be easily adapted to the shape of the irradiation chamber or even that the whole and/or parts of the irradiation chamber are made of aluminum. Due to the low price of aluminum, this enables a low-cost production of the device according to the invention.

In a further embodiment, the device further comprises a power source for operating the radiation source.

In a further embodiment, the power source is at least one battery and/or at least one rechargeable battery and/or a connection cable for an external power supply.

This embodiment has the advantage that the power supply of the device can be provided according to the wishes of the user.

In a further embodiment, the device further comprises a switch, wherein by means of the switch a power supply provided by the power source to the at least one radiation source is switched on and off.

This embodiment has the advantage that the power supply of the device can be provided if it is desired to irradiate the beverage. In this way, it is prevented that the radiation is permanently on and thus, for example, an irradiation of the user occurs.

In a further embodiment, the device further comprises a detector (e.g. inclination/tilt sensors, optical sensors, contact sensors, etc.), wherein the detector is configured to detect working states of the device.

In a further embodiment, the detector (e.g. an optical sensor of the type CCD or CMOS sensor) is configured to detect as a working state when radiation, in particular the first radiation, exits the irradiation chamber.

In order to be able to optimally monitor the state of the irradiation of the beverage and thus also the state of the refinement, it is important that the device has a detector which detects working states. Especially with regard to safety aspects, in particular whether radiation, in particular the first radiation, exits the irradiation chamber, it is particularly advantageous to detect precisely this state of an exiting radiation quickly and reliably.

In a further embodiment, the device further comprises an automated safety shutdown as a function of detected working states, in particular wherein the automated safety shutdown is configured to switch off the power supply provided by the power source to the at least one radiation source as soon as radiation, in particular the first radiation, exits the irradiation chamber.

This embodiment has the advantage that if radiation, in particular the first radiation, exits the irradiation chamber and thus a hazard to the user of the device occurs, this state is detected and an emergency shutdown of the irradiation is automatically performed to protect the user from harmful irradiation.

In a further embodiment, the device further comprises a timer, wherein after expiration of a time set by means of the timer, the power supply provided by the power source to the at least one radiation source is automatically switched off.

This embodiment has the advantage that the desired irradiation time, for example also depending on the type or volume of the beverage, can be set in advance in order to achieve optimum refinement of the beverage, and so the user no longer has be concerned about the duration of the irradiation, but the irradiation switches off automatically after the set timer has expired. In this way, a simplified use of the device is achieved and thus a greater customer comfort.

In a further embodiment, the device further comprises a display (particularly a touch display), wherein, by means of the display
a type of beverage to be irradiated,
a volume of the beverage to be irradiated,
the flow rate of the beverage through the beverage line,
the duration of the flow of the beverage through the irradiation chamber, and/or
the time set by means of the timer, is adjustable.

This embodiment has the advantage that the user of the device can very clearly and easily make certain settings and selections and thus achieve an optimized refinement of the beverage. In addition, the user has the timer set visibly in front of him and can thus see directly when the beverage has been irradiated.

The display (and thus also the functions provided by the display) can furthermore be configured as an app/computer program on the smartphone/tablet/computer. In this case, the device according to the invention comprises a sending unit configured to send the above-mentioned information/data to the corresponding terminal device/app, wherein in the app certain settings and selections can be made. Furthermore, the device according to the invention comprises a receiving unit, which is configured to receive the certain settings and selections from the terminal device/app, wherein the device according to the invention executes the selected settings and selections.

### BRIEF DESCRIPTION OF THE DRAWINGS

The invention is illustrated in more detail below, purely by way of example, with reference to working examples shown schematically in the drawing. Identical elements are labelled with the same reference numerals in the figures. The described embodiments are generally not shown true to scale and they are also not to be interpreted as limiting the invention.

FIG. 1 shows an exemplary embodiment of a device according to the invention in which the irradiation chamber has an opening which is placed over a beverage vessel.

FIG. 2 shows a schematic illustration of the irradiation of a beverage in the irradiation chamber placed over a beverage vessel.

FIG. 3 shows an exemplary embodiment of a device according to the invention in which a beverage vessel is placed in the irradiation chamber through a sealable opening that can be opened and closed.

FIG. 4 shows an exemplary embodiment of a device according to the invention in which a beverage line is configured as a flow tube and passes through the irradiation chamber, so that a beverage is irradiated in a continuous process.

FIG. 5 shows an exemplary embodiment of a device according to the invention in which the irradiation chamber has a mirror that reflects radiation onto a beverage in the flow tube.

### DETAILED DESCRIPTION OF THE DRAWINGS

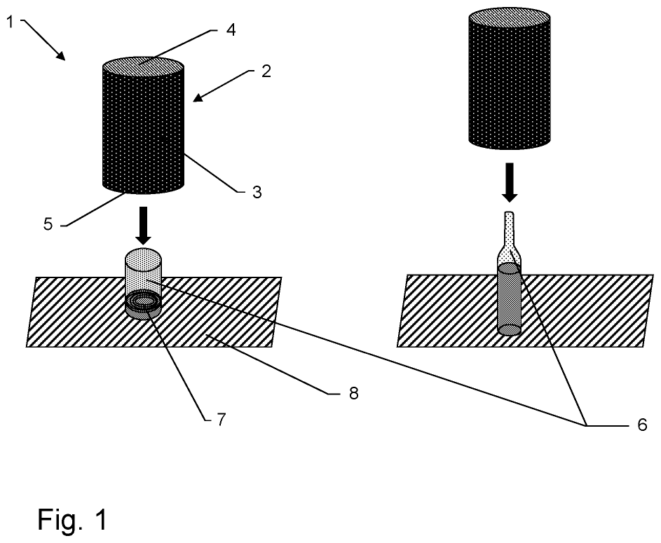

FIG. 1 shows an exemplary embodiment of the device 1 in which the irradiation chamber 2 comprises a cylindrical side wall 3 completely surrounding the irradiation chamber 2, a circular cover 4 which forms the top surface of the cylinder and the circular opening 5 (not shown in the figure), which corresponds to the base surface of the cylinder. The beverage vessel 6, which contains the beverage 7 to be refined in taste is shown in FIG. 1 as a glass (Figure left) or as a bottle (Figure right). The opening 5 of the irradiation chamber 2 is placed over the beverage vessel 6 on the straight opaque surface 8, which is shown in FIG. 1 as a table top. As soon as the opening 5 is placed on the solid, straight, light-impermeable table top 8, the opening 5 is covered and the irradiation chamber 2 is completely sealed against leakage of the first irradiation into an area outside the irradiation chamber 2. Depending on the size of the irradiation chamber 2, it is conceivable not only to use glasses or bottles as the beverage vessel 6, but also all possible vessels designed to hold the beverage and allow the first irradiation to pass through, such as large tanks in large-scale industrial beverage production.

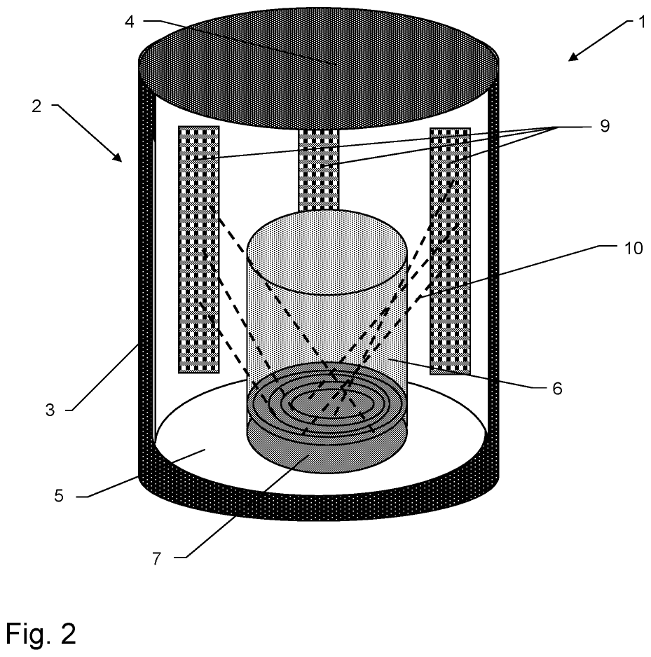

FIG. 2 shows a schematic illustration of the irradiation of a beverage 7 in the irradiation chamber 2, wherein the opening 5 has been put over a beverage vessel 6. The front of the cylindrical side wall 3 of the irradiation chamber 2 is depicted as being cut open to illustrate the irradiation of the beverage 7 inside the irradiation chamber 2. Inside the irradiation chamber 2, the beverage vessel 6 is comprised as a glass, with the beverage 7 to be flavour refined contained in the glass 6. Attached to the inside of the cylindrical side wall 3 is the radiation source 9, wherein in this exemplary embodiment the radiation source 9 is configured as three rows of UV LEDs. UV LEDs are an inexpensive way to emit the first radiation 10. However, for the realization of the device 1 according to the invention, any other radiation source can be used which is capable of emitting the first radiation 10. In FIG. 2, the three UV LED rows 9 are attached to the inside of the side wall 3. However, the radiation source 9 can also be placed at any other position within the irradiation chamber 2, in particular at the inner side of the cover 4. In this advantageous embodiment, the first radiation 10 can be emitted directly from the inner side of the cover 4 and thus hits the beverage 7 from above without the first radiation 10 having to penetrate the wall of the beverage vessel 6. Furthermore, the number and distance between the radiation sources 9 can also be varied as desired in order to realize the optimum irradiation and the optimum taste refinement of the beverage 7.

In a further advantageous embodiment of the device 1, the inside of the side wall 3 can be equipped with at least one mirror 13 (this can, for example, be positioned at a specific position on the inside of the side wall 3 or be configured as a mirror surrounding the entire inside of the side wall 3), wherein the mirror 13 reflects the emitted first radiation 10, which is not directly incident on the beverage 7, so that it then impinges on the beverage 7 (indirect irradiation of the beverage 7 with the first radiation 10). In this way, the emitted first radiation 10 can be optimally used for refining the taste of the beverage 7, since hardly any radiation 10 is absorbed away by components of the irradiation chamber 2, thus maximizing the proportion of the emitted radiation 10 that impacts on the beverage 7 and thus leads to a refinement of the taste. In this way, sufficient irradiation of the beverage 7 with the first radiation 10 and thus optimum refinement of the taste of the beverage 7 can be achieved even with a small number or low intensity of the radiation source 9.

In a further advantageous embodiment of the device 1 according to the invention, a detector (e.g. an optical sensor) registers as soon as first radiation 10 exits the irradiation chamber 2 to the outside (for example by accidentally overturning/tilting/tipping the irradiation chamber 2) and emits a visual signal (e.g. a warning light) and/or an acoustic signal (e.g. a warning sound) and/or switches off automatically the radiation source 9 and/or the power supply of the radiation source 9 in order to prevent the user from being irradiated.

The detector registers the exit of the first radiation 10 or an opening in the irradiation chamber 2, for example, by the detector being mounted inside the irradiation chamber 2 and detecting the total light intensity/photon amount when the radiation source 9 is switched on and/or off. As soon as the radiation/photons leave the irradiation chamber 2 through, for example, a leakage and/or the opened sealable opening 12, the total light intensity/photon quantity decreases, which in turn is registered by the detector. Furthermore, the detector can, for example, detect the type of radiation inside the irradiation chamber. If radiation enters the irradiation chamber 2 from the outside through, for example, a leakage and/or the opened sealable opening 12, which does not correspond to the first radiation 10 emitted by the radiation source 9, this is registered by the detector, which makes it possible to identify an leakage/opening in the irradiation chamber 2. However, the detector may also be located, for example, outside the irradiation chamber and configured to detect the first radiation 10, which is why as soon as there is leakage/opening in the irradiation chamber 2 and the first radiation 10 exits the irradiation chamber 2, this can be detected by the detector.

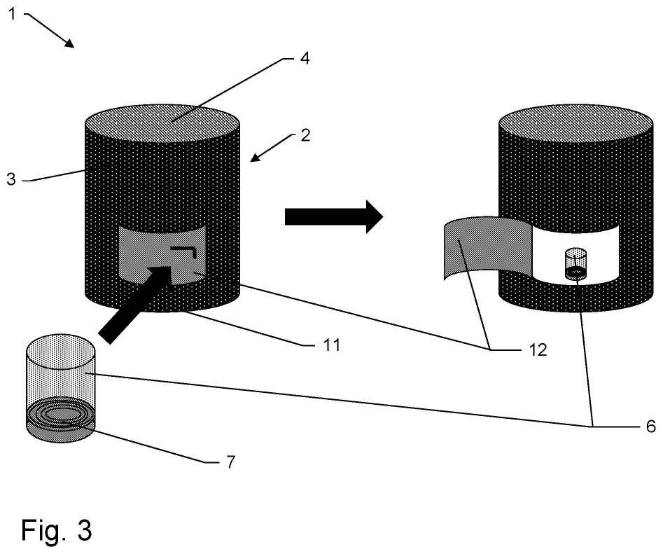

FIG. 3 shows an exemplary embodiment of the device 1 according to the invention in which the beverage vessel 6 is placed in the irradiation chamber 2 through a sealable opening 12 (in this example configured as a door) that can be opened and closed. In addition to the sealable opening 12, the irradiation chamber 2 also has a base 11 which, in this exemplary embodiment, corresponds to the base surface of the cylindrical irradiation chamber 2 and is thus arranged opposite the cover 4, the base 11 being connected to the cylindrical side wall 3 in such a way that there is no longer an opening 5 and the irradiation chamber 2 is completely sealed against the escape of the first radiation 10 when the sealable opening 12 is closed. In this way, when the door 12 is closed, no first radiation 10 can escape from the irradiation chamber 2 even if the irradiation chamber 2 is overturned, which makes the device 1 very safe for use in private rooms or bars. The sealable opening 12 can be designed as any possible shape (e.g. as a door, hatch, sluice, etc.), which allows to close the irradiation chamber 2 radiation-tight and to open it again if necessary to introduce something into the irradiation chamber 2. Furthermore, the cover 4 or the base 11 can also be designed as a removable component, which in this way functions as a sealable opening (door) 12. The number and the position of the sealable opening 12 is also freely selectable, which allows to realize certain designs or to adapt the device 1 to customer requirements.

In a further advantageous embodiment of the device 1 according to the invention, a detector registers as soon as first radiation 10 exits the irradiation chamber 2 to the outside (for example by (accidentally) opening the door 12) and emits a visual signal (e.g. a warning light) and/or an acoustic signal (e.g. a warning sound) and/or switches off automatically the radiation source 9 and/or the power supply of the radiation source 9 in order to prevent the user from being irradiated.

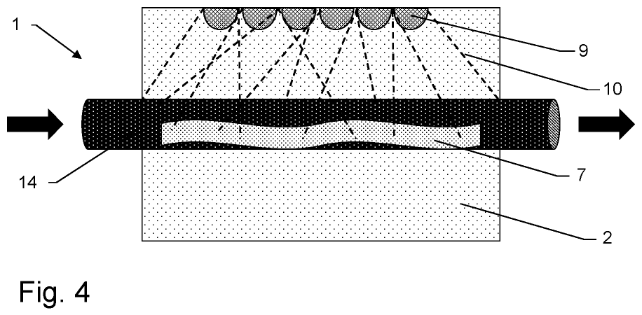

FIG. 4 shows an exemplary embodiment of the device 1 according to the invention in which the beverage line 14 is configured as a flow tube and passes through the irradiation chamber 2 so that a beverage 7 is irradiated with the first radiation 10 in a continuous process. The first radiation 10 is emitted by the radiation source 9, which in this embodiment is designed as six UV LEDs arranged in a row. The irradiation duration of the beverage 7 is determined by the flow velocity (and accordingly also by the volume flow) of the beverage 7 in the flow tube 14. If, for example, an irradiation duration of 60 s is desired for the beverage 7, the flow velocity/volume flow must be set in such a way that the beverage 7 remains in the irradiation chamber 2 (with irradiation source 9 switched on) for exactly 60 s as it flows through the flow tube 14 and leaves the irradiation chamber after this time. The flow rate/volume flow can be controlled, for example, by a pump or by the slope of a flow tube 14 designed as a downpipe. To ensure optimal irradiation of the beverage 7 with the first radiation 10, it is particularly important that the flow tube 14 is (partially) transmissive for the first radiation 10. Possible applications (but not exclusively) for this embodiment of the device 1 is the taste refinement of coffee within a coffee machine or the taste refinement of beverages in large-scale industrial beverage production, since in both cases there is (mainly) a continuous flow through pipes and longer waiting times due to a stop of the beverage flow would like to be avoided.

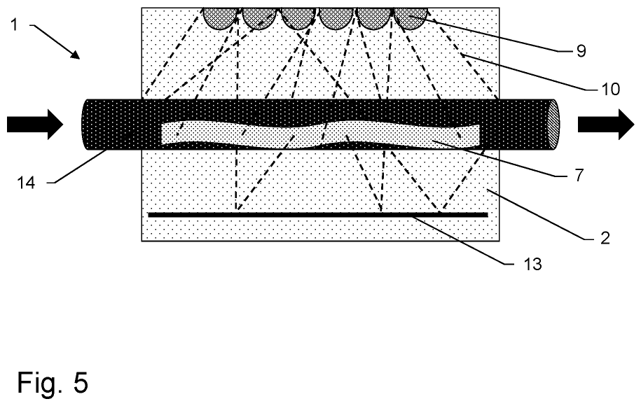

FIG. 5 shows an exemplary embodiment of the device 1 according to the invention in which the irradiation chamber 2 has a mirror 13 that reflects first radiation 10 onto the beverage 7 in the flow tube 14. In this further development of the device 1 according to FIG. 4, the irradiation chamber 2 comprises also a mirror 13 which reflects the first radiation 10 which is not incident on the beverage 7. Thus, the reflected radiation (at least partially) irradiates the beverage 7 (indirect irradiation of the beverage 7 with the first radiation 10) and thus refines its taste. In this way, the emitted first radiation 10 can be optimally used to refine the taste of the beverage 7, since little radiation 10 is absorbed by components of the irradiation chamber 2, thus maximizing the amount of the emitted radiation 10 that hits the beverage 7 and thus leads to a refinement of the taste. In this way, sufficient irradiation of the beverage 7 with the first radiation 10 and thus optimum refinement of the taste of the beverage 7 can be achieved even with a small number or low intensity of the radiation source 9.

In a further advantageous embodiment of the device 1 according to the invention, a detector registers as soon as first radiation 10 exits the irradiation chamber 2 to the outside (for example by accidentally damaging the irradiation chamber 2) and emits a visual signal (e.g. a warning light) and/or an acoustic signal (e.g. a warning sound) and/or switches off automatically the radiation source 9 and/or the power supply of the radiation source 9 in order to prevent the user from being irradiated.

For the exemplary embodiments of the device 1 shown and described in FIG. 1 to FIG. 5, the at least one radiation source 9 optionally emits the first radiation having a wavelength from a first wavelength range between 270 nm and 400 nm and the second radiation having a wavelength from a second wavelength range between 400 nm and 450 nm, wherein the beverage line 14 is irradiated with both the first radiation and the second radiation.

Although the invention is illustrated above, partly with reference to some preferred embodiments, it must be understood that numerous modifications and combinations of different features of the embodiments can be made. All of these modifications lie within the scope of the appended claims.

1. A device for refining the taste of beverages with
an irradiation chamber, wherein the irradiation chamber is configured to receive a beverage vessel, and
at least one radiation source, the at least one radiation source
being arranged within the irradiation chamber, and
is configured to emit a first radiation with a wavelength out of a wavelength range between 270 nm and 450 nm,
wherein the beverage vessel is providable in the irradiation chamber to be irradiated with the first radiation.

2. The device according to claim 1, wherein the irradiation chamber comprises
at least one side wall, the at least one side wall completely surrounding the irradiation chamber,
a cover, wherein the cover is connected to the at least one side wall, and
an opening, wherein the opening is arranged opposite the cover.

3. The device according to claim 2, wherein the irradiation chamber further comprises a base, wherein the base is arranged opposite the cover and connected to the at least one side wall such that the opening is covered.

4. The device according to claim 3, wherein the irradiation chamber further comprises at least one sealable opening, wherein the at least one sealable opening is openable and closable, wherein the beverage vessel is placeable through the at least one opened sealable opening into the irradiation chamber and the irradiation chamber is closed by the at least one sealable opening non-transmissive to the first radiation.

5. The device according to claim 1, wherein the at least one radiation source
is configured to emit the first radiation with a wavelength out of a first wavelength range between 270 nm and 400 nm, and
is configured to emit a second radiation with a wavelength out of a second wavelength range between 400 nm and 450 nm,
wherein the beverage vessel is providable in the irradiation chamber to be irradiated with both the first radiation and the second radiation.

6. The device according to claim 1, wherein the at least one radiation source is configured as an ultraviolet light-emitting diode.

7. The device according to claim 2, wherein at least one side wall and/or the cover of the irradiation chamber comprises at least one mirror, wherein the beverage vessel is indirectly irradiatable by means of the at least one mirror.

8. The device according to claim 7, wherein the at least one mirror comprises aluminum and/or gold and/or iron.

9. The device according to claim 1, wherein the device further comprises a power source for operating the radiation source, wherein the power source is at least one battery and/or at least one rechargeable battery and/or a connection cable for an external power supply.

10. The device according to claim 1, wherein the device further comprises a detector, wherein the detector is configured to detect working states of the device.

11. The device according to claim 10, wherein the detector is configured to detect as a working state when radiation exits the irradiation chamber.

12. The device according to claim 11, wherein the device further comprises an automated safety shutdown as a function of detected working states, wherein the automated safety shutdown is configured to switch off the power supply provided by the power source to the at least one radiation source as soon as radiation exits the irradiation chamber.

13. The device according to claim 9, wherein the device further comprises a timer, wherein after expiration of a time set by means of the timer, the power supply provided by the power source to the at least one radiation source is automatically switched off.

14. The device according to claim 13, wherein the device further comprises a display, wherein, by means of the display
a type of beverage to be irradiated,
a volume of the beverage to be irradiated,
a type of beverage vessel, and/or
the time set by means of the timer and thus a duration of the irradiation,
is adjustable.

15. A method for refining the taste of beverages, the method comprising the following steps:
inserting a beverage into a vessel, wherein the vessel is configured for containing the beverage,
locating the vessel within an irradiation zone, and
irradiating the irradiation zone for an irradiation time with a first radiation in the wavelength range from 270 nm to 400 nm and a second radiation in the wavelength range from 400 nm to 450 nm.

16. The method according to claim 15, wherein the method further comprises the step of sealing the irradiation zone against exit of radiation in a region outside the irradiation zone.

17. The method according to claim 15, wherein
the irradiation of the irradiation zone is performed directly by the first radiation and the second radiation and/or indirectly by a reflection of the first radiation and the second radiation,
the irradiation time is in the range of 5 s to 900 s,
a vessel wall forming the vessel is configured to
form an opening so that the first radiation and the second radiation impinge on the beverage in the vessel, and/or
be transmissive for the first radiation and the second radiation.

18. The method according to claim 15, wherein the reflection of the first radiation and the second radiation to indirectly irradiate the irradiation zone is generated by at least one mirror, wherein the at least one mirror comprises aluminum and/or gold and/or iron.

19. A device for refining the taste of beverages with
an irradiation chamber,
a beverage line, wherein the beverage line is configured to be continuously flowed through with the beverage, and
at least one radiation source, the at least one radiation source is configured to emit a first radiation with a wavelength out of a wavelength range between 270 nm and 450 nm,
wherein the beverage line and the at least one radiation source being arranged in the irradiation chamber to provide irradiation of the beverage line with the first radiation.

20. The device according to claim 19, wherein the at least one radiation source
is configured to emit the first radiation with a wavelength out of a first wavelength range between 270 nm and 400 nm, and
is configured to emit a second radiation with a wavelength out of a second wavelength range between 400 nm and 450 nm,
wherein the beverage line and the at least one radiation source being arranged in the irradiation chamber to provide irradiation of the beverage line with both the first radiation and the second radiation.

21. The device according to claim 19, wherein the irradiation chamber comprises at least one mirror, wherein the beverage line is indirectly irradiatable by means of the at least one mirror.

22. The device according to claim 19, wherein the device further comprises a detector, wherein the detector is configured to detect working states of the device.

23. The device according to claim 22, wherein the device further comprises an automated safety shutdown as a function of detected working states, wherein the automated safety shutdown is configured to switch off the power supply provided by a power source to the at least one radiation source as soon as radiation exits the irradiation chamber.

24. The device according to claim 19, wherein the device further comprises a timer, wherein after expiration of a time set by means of the timer, the power supply provided by a power source to the at least one radiation source is automatically switched off.

25. The device according to claim 24, wherein the device further comprises a display, wherein, by means of the display
a type of beverage to be irradiated,
a volume of the beverage to be irradiated,
the flow rate of the beverage through the beverage line,
the duration of the flow of the beverage through the irradiation chamber, and/or
the time set by means of the timer,
is adjustable.
